(19) United States
(12) Patent Application Publication
(10) Pub. No.: US 2022/0327760 A1
(43) Pub. Date: Oct. 13, 2022

(54) INSPECTION DATA MANAGEMENT SYSTEM FOR STRUCTURAL OBJECTS

(71) Applicant: MITSUI E&S MACHINERY CO., LTD., Tokyo (JP)

(72) Inventor: Takumi MATSUMOTO, Tokyo (JP)

(21) Appl. No.: 17/716,711

(22) Filed: Apr. 8, 2022

(30) Foreign Application Priority Data
Apr. 12, 2021 (JP) 2021-067304

(51) Int. Cl. G06T 15/04; H04N 13/156; H04N 13/204; G06T 7/33

(52) U.S. Cl. CPC G06T 15/04; H04N 13/156; H04N 13/204; G06T 7/33; G06T 2207/10016

(57) ABSTRACT

[Problem] Provided is an inspection data management system for structural objects which enables the understanding of the position of a damaged part and the extent of damage in a manner corresponding to the actual dimension of a structural object.

[Solution] The system comprises at least: a photographing terminal 12 including a photographing means and having a positional information acquisition function and a communication function; a management server 14 including an inspection information database 14a for recording inspection information about a structural object 50 as an inspection target; and an operation terminal 16 that reads out 3D data of the structural object 50 from the inspection information database 14a, executes texture mapping of image data photographed by the photographing terminal 12 to a corresponding part in the 3D data, and then performs processing for recording the obtained data in the inspection information database 14a.

### TECHNICAL FIELD

The present invention relates to a system for managing inspection data of structural objects which require regular inspections, specifically, infrastructural objects such as bridges.

### BACKGROUND ART

General structural objects become deteriorated under the influence of progression of aging, natural disasters such as earthquakes and typhoons, etc.. Therefore, the Ministry of Land, Infrastructure, Transport and Tourism, etc. issue instructions for regular inspections on infrastructural objects such as bridges. The inspections aim for the renovation or reinforcement to be performed in accordance with the state of deterioration observed through the inspections, thereby supporting residents' infrastructures.

In recent years during which communication technology has been developed, a common data management method comprises taking a photo of an inspection point in a structural object by use of a GPS-equipped camera, and transmitting image data to a server together with information about the position of the photographing site as well as the photographing time, for unified management of an image indicating a state together with the inspection time and date, and the inspection site.

Certainly, it is considered that using such a method allows the inspection time and date as well as the state of a structural object to be recorded in a reliable manner. However, in this technology, photographing of images during the inspection is not always performed in the same angular field and at the same angle. Therefore, even though a site to be inspected and to be photographed is the same as that in the previous inspection, there were some cases where it is impossible to recognize whether the state has been changed or not from the photographed image.

In view of such current conditions, the invention in Patent Document 1 is configured such that a structural object is photographed by a GPS-equipped tablet terminal and positional information about the structural object that is a photographing target is transmitted to a server, so as to confirm the presence or absence of inspection records or photographed images of the structural object. If there is an image which has been previously photographed, this image is sent back to the tablet, and the previously photographed image is displayed on a photographing screen, like a watermark, in a superposed manner. Photographing a structural object in such a state allows the structural object to be photographed in the same or similar angular field and at the same or similar angle. Furthermore, the technology disclosed in Cited Document 1 includes a matching function of automatically zooming in an out, or rotating a photographed image.

Providing such a function facilitates the comparison between a state of a structural object in a previously photographed image, and a state of the structural object in a newly photographed image.

### CITATION LIST

### Patent Document

[Patent Document 1] JP2016-133320A

### SUMMARY OF THE INVENTION

### Problems to be Solved by the Invention

The technology disclosed in Patent Document 1 facilitates the understanding of change in state of a structural object from photographed images. However, the technology disclosed in Patent Document 1 aims to record information about a structural object, with an image of an inspection point, information for identifying the photographing time and date, and the photographing position, in an associated manner. Thus, in practice, it is difficult to recognize the position and the extent, in an actual structural object, of damage, etc. shown in an image.

Accordingly, the present invention aims to provide an inspection data management system for structural objects, which enables the understanding of the position of a damaged part as well as the extent of damage in a manner corresponding to the actual dimension of a structural object.

### Solution to the Problems

In order to achieve the aim mentioned above, an inspection data management system for structural objects according to the present invention comprises, at least: a photographing terminal including a photographing means and having a positional information acquisition function and a communication function; a management server including an inspection information database for recording inspection information about a structural object as an inspection target; and an operation terminal that reads out 3D data of the structural object as the inspection target from the inspection information database on the basis of positional information provided from the photographing terminal, executes texture mapping of image data photographed by the photographing terminal to a corresponding part in the 3D data, and then performs processing for recording, in the inspection information database, 3D data obtained by the texture mapping of the image data on the 3D data.

Additionally, the operation terminal in the inspection data management system for structural objects which has the abovementioned features, may include a display means capable of displaying real-time video obtained through the photographing terminal, may specify an angle and an extent similar to an angular field of the video from the 3D data that has been read out, so as to allow 3D data of a portion as the inspection target to be displayed on the display means, and may output photographing instructions to the photographing terminal, thereby acquiring the image data. Such a feature allows the image data which has been acquired through the photographing terminal to be made similar to the display state of the 3D image which is being displayed on the display means. Therefore, the conversion ratio used for the texture mapping can be reduced.

Additionally, in the inspection data management system for structural objects which has the abovementioned features, it is preferable that the texture mapping is executed on the image data such that image data of a common site is displayable as a layer at each photographing time so as to be superposed one another, and 3D data that has been texture-mapped by previously photographed image data is displayable as necessary. Such a feature allows the change in a damaged part to be recognized in a state where the 3D data is being displayed.

Additionally, in the inspection data management system for structural objects which has the abovementioned features, it is preferable that the texture mapping is executed by specifying a plurality of feature points in the 3D data and a plurality of feature points that can be read out from the image data through the operation terminal, and by performing processing of converting the image data so as to match the feature points in the image data with the feature points in the 3D data.

### Effect of the Invention

The inspection data management system for structural objects which has the abovementioned features, enables the understanding of the position of a damaged part as well as the extent of damage in a manner corresponding to the actual dimension of a structural object.

### BRIEF DESCRIPTION OF THE DRAWINGS

FIG. 1 shows a schematic configuration of an inspection data management system for structural objects according to an embodiment.

FIG. 2 schematically illustrates the configurations as well as the functions of a photographing terminal and an operation terminal which constitute the inspection data management system for structural objects according to the embodiment.

FIG. 3 is a flowchart for explaining a method of managing inspection data by using the inspection data management system for structural objects according to the embodiment.

### DESCRIPTION OF EMBODIMENTS

Hereinafter, an embodiment pertaining to an inspection data management system for structural objects of the present invention will be described in detail, with reference to the drawings.

### [Configuration]

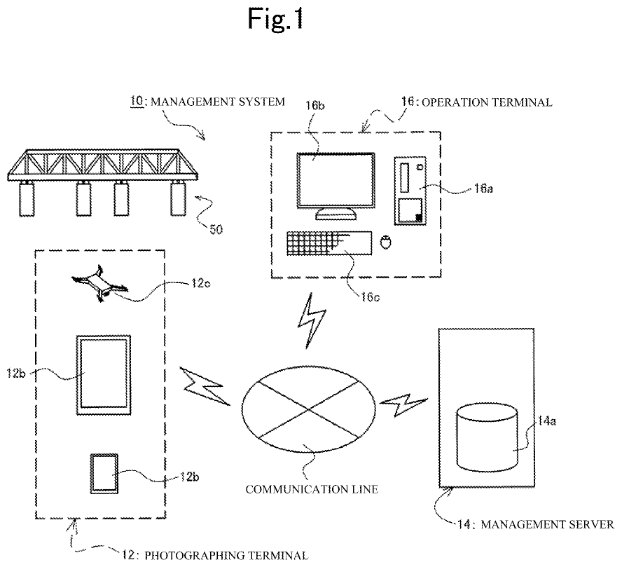

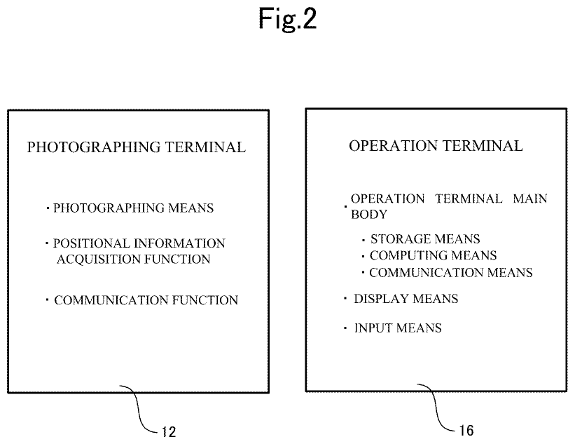

Firstly, with reference to FIGS. 1 and 2, the configuration of the inspection data management system for structural objects (hereinafter, simply referred to as a management system 10) according to the present embodiment will be described. The management system 10 according to the present embodiment comprises, at least, a photographing terminal 12, a management server 14, and an operation terminal 16. The photographing terminal 12 is a component which functions to acquire image data as digital data. The configuration thereof includes, at least, a photographing means such as a camera function capable of acquiring image data, a positional information acquisition function that uses GPS (Global Positioning System), etc., and a communication device capable of establishing data communication through Internet connection, etc.

Here, specific examples of the photographing terminal 12 include not only an intelligent mobile phone (so-called, a smartphone 12a), a tablet terminal 12b, but also an unmanned moving body (so-called, a drone 12c). When an operator on site where a structural object 50 that is an inspection target is located intends to photograph image data in accordance with instructions from the operation terminal 16 that will be described in detail below, even at a place where it is difficult to directly photograph a target due to poor footing, the use of the drone 12c, etc. allows the operator to accomplish the photographing without putting up a large scaffold, etc.

The management server 14 is a component which functions to record therein inspection information about the structural object 50 such as a bridge that is an inspection target. More specifically, the management server 14 comprises an inspection information database 14a which records therein, at least, 3D data of the structural object 50, image data pertaining to the inspection, information about the position where image data is acquired, information about the time and date when image data is acquired, among others.

The operation terminal 16 is a component which acquires image data through the photographing terminal 12, and which performs processing of associating pieces of information managed by the management server 14. Note that the operation terminal 16 may be located in an office from which instructions can be provided to a site where the photographing terminal 12 is placed. The office is not necessarily located near the site, but only needs to be equipped with a communication facility (or a communication function) which allows instructions to be provided from a remote location. The operation terminal 16 and the photographing terminal 12, as well as the operation terminal 16 and the management server 14 are connected through a wire, or directly without a wire, or indirectly through communication lines such as the Internet, such that data communication can be established therebetween.

The operation terminal 16 comprises, at least, an operation terminal main body 16a, and also includes a display means 16b and an input means 16c. The operation terminal main body 16a may include general components included in a personal computer, such as a storage means, a computing means, a communication means among others. The display means 16b may be a display capable of displaying data which has been processed by the operation terminal main body 16a, and the input means 16c may be a keyboard or a mouse.

The operation terminal 16 having such a basic configuration is capable of displaying real-time video obtained through the photographing terminal 12 on the display means 16b, and acquiring image data in an angular field as displayed on the display means 16b by outputting photographing instructions to the photographing terminal 12. The operation terminal 16 is also capable of reading out/storing 3D data of the structural object 50 that is a photographing target (inspection target) from/in the management server 14.

The 3D data which has been read out from the management server 14 is displayed on the display means 16b. Note that 3D data may be displayed together with a video obtained through the photographing terminal 12, or as a result of switching of a display state. By specifying, for the 3D data displayed on the display means 16b, positional information obtained through the photographing terminal 12 and the angle and extent similar to those of an angular field in real-time video, it becomes possible to display 3D data of a portion that is an inspection target.

The operation terminal 16 outputs photographing instructions to the photographing terminal 12, thereby obtaining image data having an angular field identical to or similar to that of 3D data displayed on the display means 16b. Since the image data acquired by the photographing terminal 12 includes distortions caused by a lens, a photographing angle, or a distance, the operation terminal 16 performs conversion through the computing means in accordance with the configuration plane of the 3D data. Specifically, a plurality of corresponding feature points are specified respectively for 3D data and image data, and the image data is projected in a coordinate system (2D coordinate system or 3D coordinate system). Subsequently, the conversion can be performed such that the plane distance (for example, the distance in the X-Y coordinate system) between feature points in the image data projected in the coordinate system becomes equivalent to the plane distance between corresponding feature points in the 3D data.

The computing means executes a texture mapping processing for attaching image data which has been converted in accordance with the configuration plane, to the surface of the 3D data. The texture mapping can be executed such that, before the attachment, depth information given to the feature points in the 3D data is provided to respective feature points having the adjusted plane distances. This processing helps visual and sensory understanding of which part of a structural object is an inspection point in the 3D data.

In the computing means, if the photographing is performed on the inspection points having common positional information (common site) more than once at different times, a layer is created for each photographing time, and texture mapping is displayed in a superposed manner, and then, processing for recording in the inspection information database 14a in the management server 14 is performed. This processing helps understanding of a previous state of the inspection point, if necessary, and visual and sensory understanding of the progress and the location of the degradation.

### [Method]

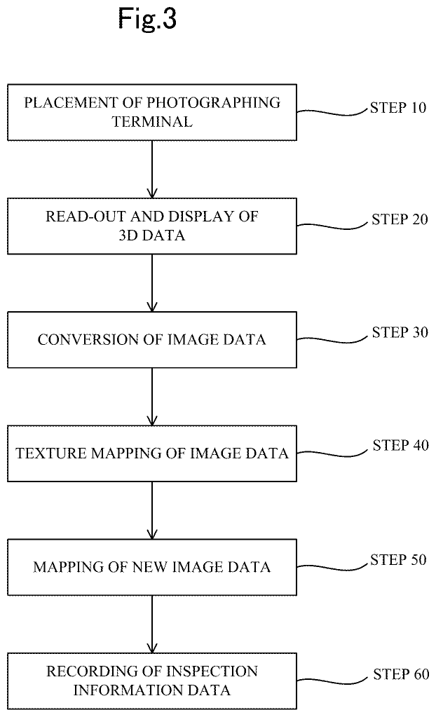

Next, a method for creating and managing inspection data by using the management system 10 which has the configuration described above, will be described with reference to FIG. 3.

Firstly, the photographing terminal 12 for photographing an inspection portion in the structural object 50 that is an inspection target, is placed, and real-time video obtained through the photographing terminal 12 is transmitted to the operation terminal 16 (step 10: placement of photographing terminal).

The operation terminal 16 reads out 3D data from the management server 14 in a state where video corresponding to an inspection point in the structural object 50 is being displayed on the display means 16b, and then, displays the 3D data on the display means 16b. At this time, the video obtained through the photographing terminal 12 and the 3D data read out from the management server 14 may be displayed in parallel on the same screen, or may be displayed by switching screens (step 20: read-out and display of 3D data).

The operation terminal 16 outputs photographing instructions to the photographing terminal 12, and acquires image data. Feature points corresponding to the feature points defined in the 3D data are defined in the acquired image data, and then, conversion in accordance with the configuration plane is performed on the image data (step 30: conversion of image data).

The texture mapping processing for attaching, to the 3D data, the image data on which conversion in accordance with the configuration plane of the 3D data has been performed, is carried out. In the texture mapping, the image data is attached to the 3D data as an image layer, and the respective layers are associated with information about the position where image data is photographed, information about the time and date when image data is photographed (step 40: texture mapping of image data).

During the step of executing texture mapping of image data, when the image data has been already attached to the 3D data, image data which will be newly attached, is attached to the 3D data as a layer different from that of the image data which has been previously associated (step 50: mapping of new image data).

Data (inspection information data) obtained by attaching (associating), to 3D data, image data as a layer in which positional information as well as time and date information have been defined, is recorded in the inspection information database 14a of the management server 14 (step 60: recording of inspection information data).

### [Effect]

Managing inspection data by use of the management system 10 mentioned above, enables the storage and management of 3D data of a structural object 50 such as a bridge that is an inspection target, topped with (attached by) image data as it is. Accordingly, it becomes possible to understand the position of a damaged part as well as the extent of damage in a manner corresponding to the actual dimension of the structural object 50 such as a bridge. Additionally, since image data to be attached to 3D data is recorded at each photographing time and date as a layer so as to be superposed one another, it is possible to recognize and judge the degree of damage (the degree of progress of change and deterioration, etc.) as compared with the past image data, if necessary.

Besides, since 3D data and image data, positional information, time and date information, etc. are recorded in a state of being associated with one piece of data (3D data), it is possible to record and manage the data and information in a single database.

Furthermore, when the drone 12c is used as the photographing terminal 12, photographing work can be automated, and it is possible to reduce effort and time required for putting up a scaffold, etc. even at a place where it is difficult to perform photographing.

### INDUSTRIAL APPLICABILITY

In the embodiment mentioned above, a bridge is mentioned as one example of the structural object 50 that is an inspection target. However, the invention is applicable to the management of inspection data of steel structural objects other than bridges, such as lift pillars at ski resorts, gates for sluice gates, float bridges, gas tanks and petroleum tanks, and iron towers.

### DESCRIPTION OF THE REFERENCE CHARACTERS

10 management system

12 photographing terminal

12a smartphone

12b tablet terminal

12c drone

14 management server

14a inspection information database

16 operation terminal

16a operation terminal main body

16b display means

16c input means

50 structural object

1. An inspection data management system for structural objects, comprising at least:
a photographing terminal including a photographing means and having a positional information acquisition function and a communication function;
a management server including an inspection information database for recording inspection information about a structural object as an inspection target; and
an operation terminal that reads out 3D data of the structural object as the inspection target from the inspection information database on the basis of positional information provided from the photographing terminal, executes texture mapping of image data photographed by the photographing terminal to a corresponding part in the 3D data, and then performs processing for recording, in the inspection information database, 3D data obtained by the texture mapping of the image data on the 3D data, wherein
the operation terminal includes a display means capable of displaying real-time video obtained through the photographing terminal, specifies an angle and an extent similar to an angular field of the video from the 3D data that has been read out, so as to allow 3D data of a portion as the inspection target to be displayed on the display means, and outputs photographing instructions to the photographing terminal, thereby acquiring the image data.

2. The inspection data management system according to claim 1, wherein
the texture mapping is executed on the image data such that image data of a common site is displayable as a layer at each photographing time so as to be superposed one another, and
3D data that has been texture-mapped by previously photographed image data is displayable as necessary.

3. The inspection data management system according to claim 1, wherein
the texture mapping is executed by specifying a plurality of feature points in the 3D data and a plurality of feature points that can be read out from the image data through the operation terminal, and
by performing processing of converting the image data so as to match the feature points in the image data with the feature points in the 3D data.

4. The inspection data management system according to claim 2, wherein
the texture mapping is executed by specifying a plurality of feature points in the 3D data and a plurality of feature points that can be read out from the image data through the operation terminal, and
by performing processing of converting the image data so as to match the feature points in the image data with the feature points in the 3D data.
